(19) United States
(12) Patent Application Publication
(10) Pub. No.: US 2019/0304469 A1
(43) Pub. Date: Oct. 3, 2019

(54) VOICE APPLICATION SYSTEM AND METHOD THEREOF

(71) Applicant: Chunghwa Picture Tubes, LTD., Taoyuan City (TW)

(72) Inventor: Chien-Hung Chen, New Taipei City (TW)

(73) Assignee: Chunghwa Picture Tubes, LTD., Taoyuan City (TW)

(21) Appl. No.: 16/004,458

(22) Filed: Jun. 11, 2018

(30) Foreign Application Priority Data
Mar. 30, 2018 (CN) 201810275904.3

(51) Int. Cl. G10L 17/02

(52) U.S. Cl. CPC G10L 17/02

(57) ABSTRACT

The disclosure provides a voice application system and a method thereof. The method includes: executing a voice program; receiving a first voice signal; analyzing the first voice signal through the voice program to obtain a first voice feature corresponding to the first voice signal; storing a corresponding relationship of the first voice feature and a first function selected by user into a database through the voice program; and performing voice recognition operation through the voice program according to the corresponding relationship in the database.

### CROSS-REFERENCE TO RELATED APPLICATION

This application claims the priority benefit of China application serial no. 201810275904.3, filed on Mar. 30, 2018. The entirety of the above-mentioned patent application is hereby incorporated by reference herein and made a part of this specification.

### BACKGROUND

### Technical Field

The present disclosure relates to a voice application system and a method thereof.

### Description of Related Art

Currently, when using devices such as a computer and a mobile phone, communication with the device is carried out via an input interface such as a mouse, a keyboard, a touch or a gesture, and the input mode is a fixed mode which cannot be flexibly defined by user. In addition, those input methods require use of body (e.g., hands or feet). For disabled users, e.g., those who have difficulty in using their bodies (e.g., hands or feet) for making input, those input methods are not applicable. Therefore, the input mode with use of natural language such as face recognition, fingerprint recognition, voice and so on is needed to carry out communication with the device and make input.

### SUMMARY

The disclosure provides a voice application system and a method thereof, which allow user to define his/her own voice to correspond to different applications with high flexibility.

The disclosure provides a voice application system. The system includes an input device, a database and processor. The processor is electrically connected to the input device and the database. The processor executes a voice program. The input device receives a first voice signal. The voice program analyzes the first voice signal to obtain a first voice feature corresponding to the first voice signal. The voice program stores a corresponding relationship of the first voice feature and a first function selected by the user into the database, and the voice program performs voice recognition operation according to the corresponding relationship in the database.

According to an embodiment of the disclosure, before the voice program analyses the first voice signal to obtain the first voice feature corresponding to the first voice signal, the voice program performs pre-processing operation to the first voice signal.

According to the embodiment of the disclosure, the system further includes an output apparatus. After the voice program analyses the first voice signal to obtain the first voice feature corresponding to the first voice signal, the output apparatus outputs a first recognition result corresponding to the first voice feature. When the input device receives first confirmation information representing that the first recognition result is identical to the first voice signal, the input device receives first selection information used for selecting the first function. The voice program performs an operation of storing the corresponding relationship of the first voice feature and the first function selected by the user into the database according to the first selection information.

According to an embodiment of the invention, when the voice program performs voice recognition operation according to the corresponding relationship in the database, the input device receives a second voice signal. The voice program analyses the second voice signal to obtain a second voice feature corresponding to the second voice signal. The voice program determines whether the second voice feature is consistent with the first voice feature in the database. When the voice program determines that the second voice feature is consistent with the first voice feature in the database, the output apparatus outputs prompt information to inquire the user whether the first function is to be performed. When the input device receives second confirmation information used for performing the first function according to the prompt information, the voice program performs the first function.

According to an embodiment of the disclosure, the system further includes an output apparatus. The input device receives a third voice signal used for instructing to close the voice program. The voice program analyses the third voice signal to obtain a third voice feature corresponding to the third voice signal. The output apparatus outputs a third recognition result corresponding to the third voice feature. When the input device receives third confirmation information representing that the third recognition result is identical to the third voice signal, the input device receives second selection information used for closing the voice program, and the voice program closes the voice program according to the second selection information.

According to an embodiment of the disclosure, the system further includes an output apparatus. The input device receives a fourth voice signal. The voice program analyses the fourth voice signal to obtain a fourth voice feature corresponding to the fourth voice signal. The output apparatus outputs a fourth recognition result corresponding to the fourth voice feature. When the input device receives fourth confirmation information representing that fourth recognition result is identical to the fourth voice signal, the input device receives third selection information used for deleting the corresponding relationship of the first voice feature and the first function. The voice program deletes the corresponding relationship of the first voice feature and the first function in the database according to the third selection information.

The disclosure provides a voice application method. The method includes the following steps: executing a voice program; receiving a first voice signal; analyzing the first voice signal through the voice program to obtain a first voice feature corresponding to the first voice signal; storing a corresponding relationship of the first voice feature and a first function selected by the user into the database through the voice program; and performing voice recognition operation according to the corresponding relationship in the database through the voice program.

According to an embodiment of the disclosure, before the step of analyzing the first voice signal through the voice program to obtain the first voice feature corresponding to the first voice signal, the method further includes performing a pre-processing operation to the first voice signal through the voice program.

According to an embodiment of the disclosure, after the voice program analyses the first voice signal to obtain the first voice feature corresponding to the first voice signal, the method further includes the following steps: outputting a first recognition result corresponding to the first voice feature; and when first confirmation information representing that the first recognition result is identical to the first voice signal is received, receiving a first selection information used for selecting the first function, storing a corresponding relationship of the first voice feature and the first function selected by the user into the database according to the first selection information through the voice program.

According to an embodiment of the disclosure, the step of performing the voice recognition operation according to the corresponding relationship in the database through the voice program includes the following steps: receiving a second voice signal; analyzing the second voice signal through the voice program to obtain a second voice feature corresponding to the second voice signal; determining whether the second voice feature is consistent with the first voice feature in the database through the voice program; when the voice program determines that the second voice feature is consistent with the first voice feature in the database, outputting prompt information to inquire the user whether the first function is to be performed; and when second confirmation information used for performing the first function is received according to the prompt information, performing the first function through the voice program.

According to an embodiment of the disclosure, the method further includes the following steps: receiving a third voice signal for instructing to close the voice program; analyzing the third voice signal through the voice program to obtain a third voice feature corresponding to the third voice signal; outputting a third recognition result corresponding to the third voice feature; and when third confirmation information representing that the third recognition result is identical to the third voice signal is received, receiving second selection information used for closing the voice program, closing the voice program according to the second selection information through the voice program.

According to an embodiment of the disclosure, the method further includes the following steps: receiving a fourth voice signal; analyzing the fourth voice signal through the voice program to obtain a fourth voice feature corresponding to the fourth voice signal; outputting a fourth recognition result corresponding to the fourth voice feature; when fourth confirmation information representing that the fourth recognition result is identical to the fourth voice signal is received, receiving third selection information used for deleting the corresponding relationship of the first voice feature and the first function, deleting the corresponding relationship of the first voice feature and the first function in the database according to the third selection information through the voice program.

Based on the above, the disclosure provides a voice application system and a method thereof, which allow the user to define his/her voice to correspond to different applications with high flexibility. The method of using voice input to define application includes the following four parts: adding, using, closing or deleting user-defined voice. The process flow of the four parts are clearly defined. For those who have difficulty in using conventional input methods such as keyboard, mouse or touch, the disclosure provides a better method for canying out communication with device.

### BRIEF DESCRIPTION OF THE DRAWINGS

FIG. 1 is a schematic view of a voice application system according to an embodiment of the disclosure.

FIG. 2 is a diagram showing process flow of adding user-defined voice to a voice application system according to an embodiment of the disclosure.

FIG. 3 is a diagram showing process flow of performing voice recognition operation through a voice application system according to an embedment of the disclosure.

FIG. 4 is a diagram showing process flow of closing a voice program executed by voice application system according to an embodiment of the disclosure.

FIG. 5 is a diagram showing process flow of deleting corresponding relationship of voice feature and function selected by user stored in database according to an embodiment of the disclosure.

FIG. 6 is a diagram showing process flow of a voice application method according to an embodiment of the disclosure.

### DESCRIPTION OF THE EMBODIMENTS

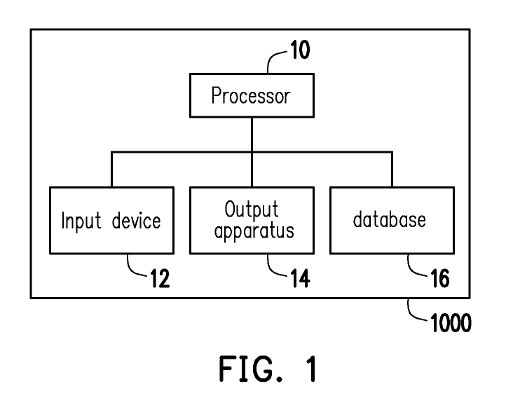

Referring to FIG. 1, a voice application system 1000 includes a processor 10, an input device 12, an output apparatus 14 and a database 16. The input device 12, the output apparatus 14 and the database 16 are electrically connected to the processor 10.

The processor 10 may be a central processing unit (CPU) or a programmable general purpose or special purpose microprocessor, a digital signal processor (DSP), a programmable controller, an application specific integrated circuit (ASIC) or other similar element or a combination of the above.

The input device 12 may be a microphone, a keyboard, a mouse or a touch screen or other element capable of receiving user's input or a combination of the above.

The output apparatus 14 may be a screen, a speaker or other element capable of outputting information to the user or a combination of the above.

The database 16 may be a fixed or a movable random access memory (RAM) of any forms, a read-only memory (ROM), a flash memory or a similar element or a combination of the above.

In the embodiment, a plurality of program segments are stored in the database 16 of the voice application system 1000. After being installed, the program segments are executed by the processor 10. For example, the database 16 includes a plurality of modules, the modules are used to respectively perform various operations applied to the voice application system 1000, wherein each of the modules consists of one or more program segments, which should not be construed as a limitation to the disclosure. Each of the operations of the voice application system 1000 may be realized in the form of other hardware.

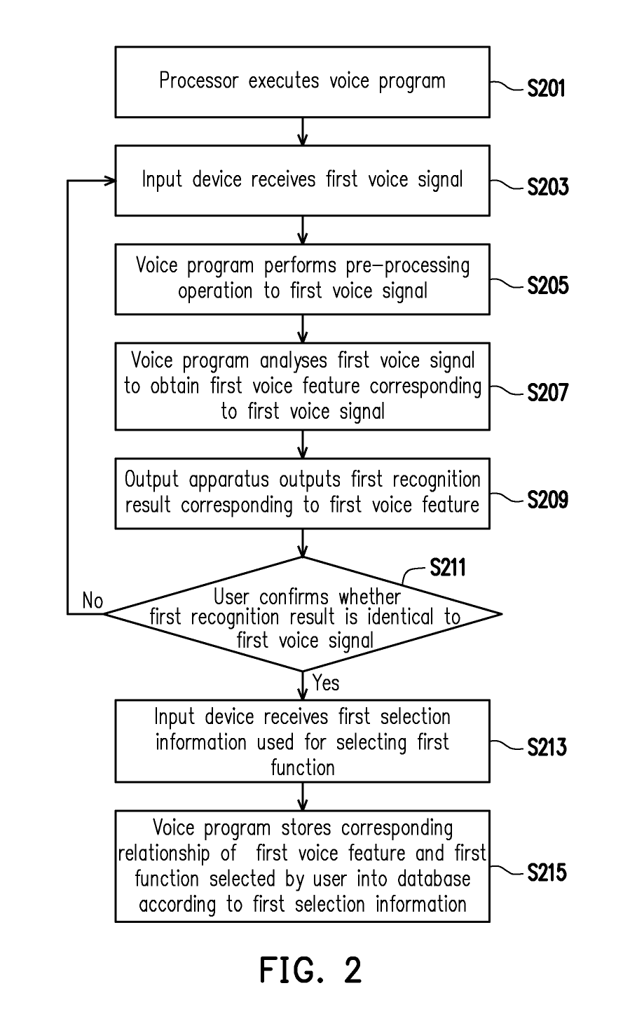

Referring to FIG. 2, when the user is to add a user-defined voice to the voice application system 1000, in step S201, the processor 10 may execute voice program. The voice program is, for example, pre-stored in the database 16. After the processor 10 executes the voice program, the voice program may automatically activate the input device 12 (e.g., activate microphone). Thereafter, in step S203, the input device 12 may receive the first voice signal. The first voice signal is, for example, user's sound. Here, the first voice signal may be assumed as voice of “activating camera”. Next, in step S205, the voice program performs pre-processing operation to the first voice signal. The pre-processing operation is, for example, used for eliminating noise, which should not be construed as a limitation to the disclosure. In step S207, the voice program analyses the first voice signal that is processed through the pre-processing operation to obtain a first voice feature corresponding to the first voice signal. The output apparatus 14 outputs a first recognition result (e.g., text or voice corresponding to the first voice signal) corresponding to the first voice feature in step S209, thereby the user can determine whether the determination result of the voice application system 1000 is correct.

Thereafter, in step S211, the user may confirm whether the first recognition result output by the output apparatus 14 is identical to the first voice signal (i.e., user's sound). If not, the step S203 is resumed and performed. If yes, in step S213, the input device 12 may receive first confirmation information input by the user for representing that the first recognition result is identical to the first voice signal, and the user uses the input device 14 for making input such that the input device 14 receives first selection information for selecting the first function. Here, the first function is assumed as a function of “activating camera”. Thereafter, in step S215, the voice program may store a corresponding relationship of the first voice feature (e.g., voice feature of “activating camera”) and the first function (e.g., function of “activating camera”) selected by the user into the database 16 according to first selection information input by the user.

Thereafter, the voice program can perform voice recognition operation according to the corresponding relationship of the voice feature and the function selected by the user in the database 16.

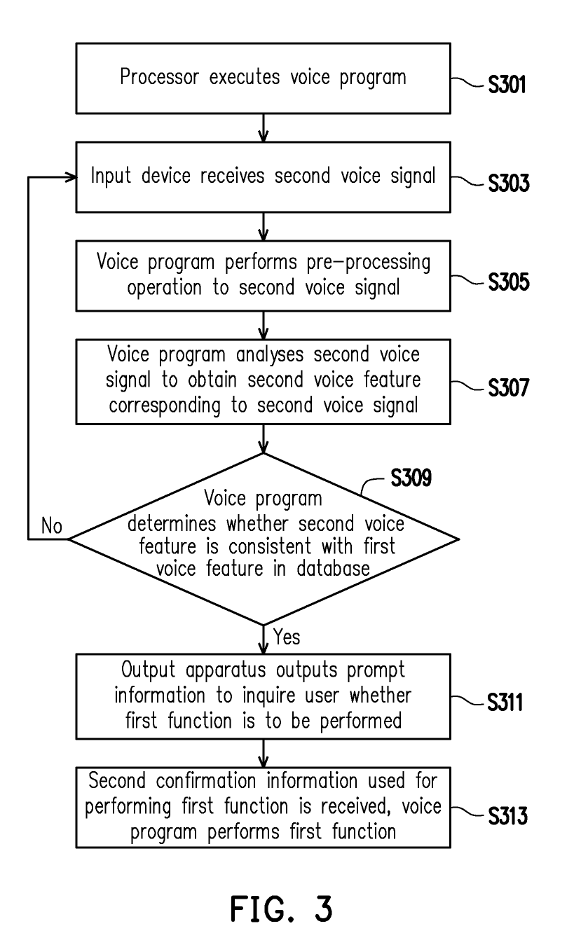

Referring to FIG. 3, in step S301, the processor 10 may execute the voice program to perform voice recognition operation. After the processor 10 executes the voice program, the voice program may automatically activate the input device 12 (e.g., activate microphone). Thereafter, in step S303, the input device 12 may receive a second voice signal. The second voice signal is, for example, user's sound. Here, the second voice signal is assumed as a voice of “activating camera”. Thereafter, in step S305, the voice program performs pre-processing operation to the second voice signal. The pre-processing operation is, for example, used for eliminating noise, which should not be construed as a limitation to the disclosure. In step S307, the voice program analyses the second voice signal processed through the pre-processing operation to obtain a second voice feature corresponding to the second voice signal. Moreover, in step S309, the voice program determines whether the second voice feature is consistent with the voice feature (e.g., first voice feature) stored in the database.

When the voice program determines that the second voice feature is not consistent with the voice feature stored in the database, the step S303 may be resumed and performed. When the voice program determines that the second voice feature is consistent with the voice feature (e.g., first voice feature) stored in the database, in step S311, the output apparatus 14 outputs prompt information to inquire the user whether the first function (e.g., function of “activating camera”) corresponding to the first voice feature is to be performed. When the input device 12 receives second confirmation information used for performing the first function, the voice program may perform the first function in step S313.

Additionally, the user may further use voice recognition to close the activated voice program.

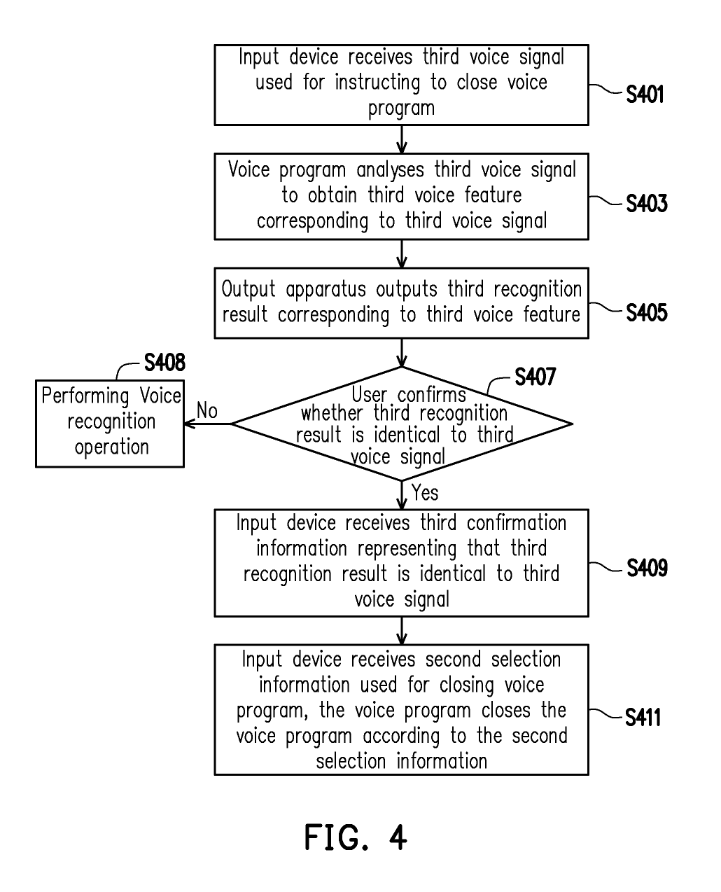

Referring to FIG. 4, in step S401, when the voice application system 1000 is executing the voice program and activating the input device 12 (e.g., microphone), the input device 12 may receive a third voice signal used for instructing to close voice program. Here, the third voice signal is, for example, user's sound indicating “closing voice program”. Thereafter, in step S403, the voice program may analyze the third voice signal to obtain a third voice feature corresponding to the third voice signal. Next, in step S405, the output apparatus 14 outputs a third recognition result (e.g., text or voice corresponding to third voice signal) corresponding to the third voice feature, thereby the user can determine whether the determination result of the voice application system 1000 is correct.

Thereafter, in step S407, the user may confirm whether the third recognition result output by the output apparatus 14 is identical to the third voice signal (i.e., user's sound). If not, in step S408, the voice recognition operation shown in FIG. 3 may continue to be performed. If yes, in step S409, the input device 12 may receive third confirmation information input by the user for representing that the third recognition result is identical to the third voice signal. Lastly, in step S411, the input device 12 may receive second selection information input by the user for closing voice program, and the voice program may close the voice program according to the second selection information.

Moreover, the user may further use voice recognition to delete the corresponding relationship of the voice feature stored and the function selected by the user in the database 16.

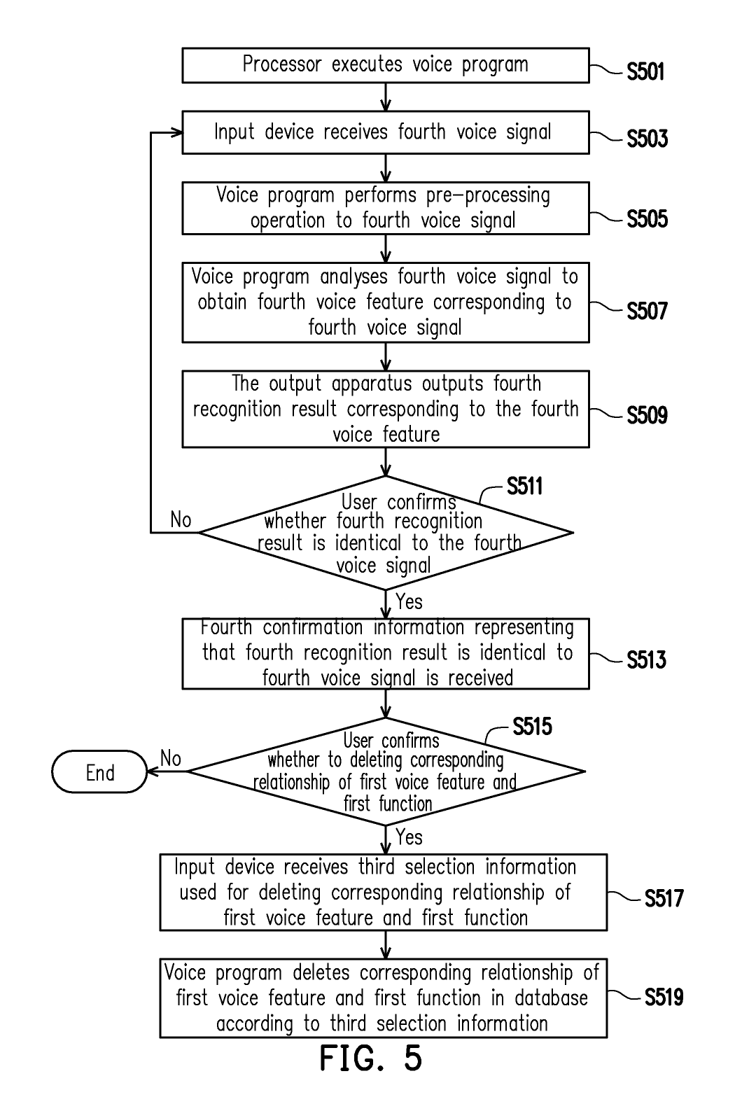

Referring to FIG. 5, when the user is to delete the corresponding relationship of the voice feature stored and the function selected by the user in the database 16, in step S501, the processor 10 may execute the voice program. After the processor 10 executes the voice program, the voice program may automatically activate the input device 12 (e.g., activate microphone). Thereafter, in step S503, the input device 12 may receive the fourth voice signal. The fourth voice signal is, for example, user's sound. Here, the fourth voice signal is assumed as the voice of “activating camera”. Thereafter, in step S505, the voice program performs pre-processing operation to the fourth voice signal. The pre-processing operation is, for example, used for eliminating noise, which should not be construed as a limitation to the disclosure. In step S507, the voice program analyses the fourth voice signal that is processed through the pre-processing operation to obtain a fourth voice feature correspond to the fourth voice signal. The output apparatus 14 outputs a fourth recognition result (e.g., text or voice corresponding to fourth voice signal) corresponding to the fourth voice feature in step S509, thereby the user can determine whether the determination result of the voice application system 1000 is correct.

Thereafter, in step S511, the user can confirm whether the fourth recognition result output by the output apparatus 14 is identical to the fourth voice signal (i.e., user's sound). If not, the step S503 may be resumed and performed. If yes, in step S513, the input device 12 may receive fourth confirmation information input by the user for representing that the fourth recognition result is identical to the fourth voice signal. Thereafter, in step S515, the user may confirm whether to delete the corresponding relationship of the first voice feature and the first function in the database 16. If not, the process flow shown in FIG. 5 may be ended. If yes, in step S517, the input device 12 may receive third selection information used for deleting the corresponding relationship of the first voice feature and the first function. Lastly, in step S519, the voice program may delete the corresponding relationship of the first voice feature and the first function in the database according to the third selection information.

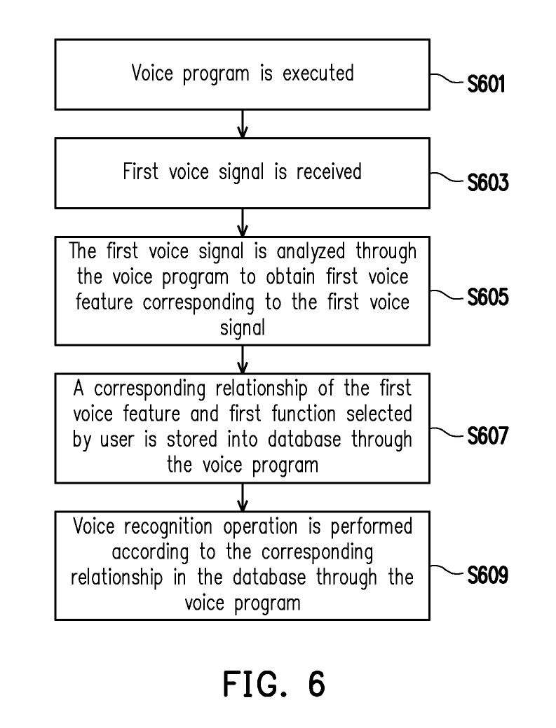

FIG. 6 is a diagram showing flow chart of a voice application method according to an embodiment of the disclosure.

Referring to FIG. 6, in step S601, the processor 10 executes the voice program. In step S603, the input device 12 receives the first voice signal. In step S605, the voice program analyzes the first voice signal to obtain the first voice feature corresponding to the first voice signal. In step S607, the voice program stores the corresponding relationship of the first voice feature and the first function selected by the user into the database 16. Lastly, in step S609, the voice program performs voice recognition operation according to the corresponding relationship in the database 16.

In summary, the disclosure provides a voice application system and a method thereof, which allow the user to define his/her voice to correspond to different applications with high flexibility. The method of using voice input to define application includes the following four parts: adding, using, closing or deleting user-defined voice. The process flow of the four parts are clearly defined. For those who have difficulty in using conventional input methods such as keyboard, mouse or touch, the disclosure provides a better method for carrying out communication with device.

What is claimed is:

1. A voice application system, comprising:
an input device;
a database; and
a processor, electrically connected to the input device and the database, wherein the processor executes a voice program,
the input device receives a first voice signal,
the voice program analyses the first voice signal to obtain a first voice feature corresponding to the first voice signal,
the voice program stores a corresponding relationship of the first voice feature and a first function selected by user into the database, and
the voice program performs a voice recognition operation according the corresponding relationship in the database.

2. The voice application system as claimed in claim 1, wherein before the voice program analyses the first voice signal to obtain the first voice feature corresponding to the first voice signal,
the voice program performs a pre-processing operation to the first voice signal.

3. The voice application system as claimed in claim 1, the system further comprising:
an output apparatus, wherein after the voice program analyses the first voice signal to obtain the first voice feature corresponding to the first voice signal,
the output apparatus outputs a first recognition result corresponding to the first voice feature,
when the input device receives a first confirmation information representing that the first recognition result is identical to the first voice signal, the input device receives a first selection information for selecting the first function, the voice program performs operation of storing the corresponding relationship of the first voice feature and the first function selected by the user into the database according to the first selection information.

4. The voice application system as claimed in claim 3, wherein in the operation that the voice program performs the voice recognition operation according to the corresponding relationship in the database,
the input device receives a second voice signal,
the voice program analyses the second voice signal to obtain a second voice feature corresponding to the second voice signal,
the voice program determines whether the second voice feature is consistent with the first voice features in the database,
when the voice program determines that the second voice feature is consistent with the first voice feature in the database, the output apparatus outputs a prompt information to inquire the user whether the first function is to be performed,
when the input device receives a second confirmation information for performing the first function according to the prompt information, the voice program performs the first function.

5. The voice application system as claimed in claim 1, the system further comprising:
an output apparatus, wherein
the input device receives a third voice signal for instructing to close the voice program,
the voice program analyses the third voice signal to obtain a third voice feature corresponding to the third voice signal,
the output apparatus outputs a third recognition result corresponding to the third voice feature,
when the input device receives a third confirmation information representing that the third recognition result is identical to the third voice signal, the input device receives a second selection information for closing the voice program, the voice program closes the voice program according to the second selection information.

6. The voice application system as claimed in claim 1, the system further comprising:
an output apparatus, wherein
the input device receives a fourth voice signal,
the voice program analyses the fourth voice signal to obtain a fourth voice feature corresponding to the fourth voice signal,
the output apparatus outputs a fourth recognition result corresponding to the fourth voice feature,
when the input device receives a fourth confirmation information representing that the fourth recognition result is identical to the fourth voice signal, the input device receives a third selection information for deleting the corresponding relationship of the first voice feature and the first function, the voice program deletes the corresponding relationship of the first voice feature and the first function in the database according to the third selection information.

7. A voice application method, comprising:
executing a voice program;
receiving a first voice signal;
analyzing the first voice signal through the voice program to obtain a first voice feature corresponding to the first voice signal;
storing a corresponding relationship of the first voice feature and a first function selected by user into a database through the voice program; and
performing a voice recognition operation according to the corresponding relationship in the database through the voice program.

8. The voice application method as claimed in claim 7, wherein before the voice program analyses the first voice signal to obtain the first voice feature corresponding to the first voice signal, the method further comprises:
performing a pre-processing operation to the first voice signal through the voice program.

9. The voice application method as claimed in claim 7, wherein after analyzing the first voice signal to obtain the first voice feature corresponding to the first voice signal through the voice program, the method further comprises:
outputting a first recognition result corresponding to the first voice feature; and
when a first confirmation information representing that the first recognition result is identical to the first voice signal is received, receiving a first selection information for selecting the first function, and storing the corresponding relationship of the first voice feature and the first function selected by user into the database according to the first selection information through the voice program.

10. The voice application method as claimed in claim 7, wherein the step of performing the voice recognition operation through the voice program according to the corresponding relationship in the database comprises:
receiving a second voice signal;
analyzing the second voice signal through the voice program to obtain a second voice feature corresponding to the second voice signal;
determining whether the second voice feature is consistent with the first voice feature in the database through the voice program;
when the voice program determines that the second voice feature is consistent with the first voice feature in the database, outputting a prompt information to inquire the user whether the first function is to be performed; and
when a second confirmation information for performing the first function is received according to the prompt information, performing the first function through the voice program.

11. The voice application method as claimed in claim 7, wherein the method further comprises:
receiving a third voice signal for instructing to close the voice program;
analyzing the third voice signal through the voice program to obtain a third voice feature corresponding to the third voice signal;
outputting a third recognition result corresponding to the third voice feature; and
when a third confirmation information representing that the third recognition result is identical to the third voice signal is received, receiving a second selection information for closing the voice program, closing the voice program according to the second selection information through the voice program.

12. The voice application method as claimed in claim 7, the method further comprising:
receiving a fourth voice signal;
analyzing the fourth voice signal through the voice program to obtain a fourth voice feature corresponding to the fourth voice signal;
outputting a fourth recognition result corresponding to the fourth voice feature;
when a fourth confirmation information representing that the fourth recognition result is identical to the fourth voice signal is received, receiving a third selection information for deleting the corresponding relationship of the first voice feature and the first function, and deleting the corresponding relationship of the first voice feature and the first function in the database according to the third selection information through the voice program.
